(19) United States
(12) Patent Application Publication
(10) Pub. No.: US 2006/0115013 A1
(43) Pub. Date: Jun. 1, 2006

(54) Blind modulation classification apparatus for use in satellite communication system and method thereof

(76) Inventors: Il Han Kim, Daejon (KR); Ho-Kyom Kim, Daejon (KR); Deock-Gil Oh, Daejon (KR); Ho-Jin Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 11/184,592

(22) Filed: Jul. 19, 2005

(30) Foreign Application Priority Data
Nov. 29, 2004 (KR) 10-2004-0098786

(51) Int. Cl. H04L 23/02

(52) U.S. Cl. 375/262

(57) ABSTRACT

A blind modulation classification apparatus in a satellite communication system improves performance in non-ideal communication environment having frequency error and phase error, by reducing computational burden of test statistic and possibility of numerical error of hardware, with computation of likelihood for each stage independently. The blind modulation classification apparatus includes a plurality of likelihood computing units, each for computing a likelihood value of a received baseband signal for corresponding one of a plurality of modulation schemes; a maximum selecting and setting units for selecting the maximum among the calculated likelihood values and setting a flag corresponding to the maximum to ‘1’ and the other flags to ‘0’; a plurality of flag summing-up units for summing up the flags of the plurality of the modulation schemes; and a modulation scheme selecting unit for selecting the maximum among the summed-up values and selecting the modulation scheme corresponding to the selected value.

### FIELD OF THE INVENTION

The present invention relates to a blind modulation classification apparatus for use in a satellite communication system and a method thereof; and, more particularly, to a blind modulation classification apparatus for classifying modulation scheme that is applied to a received signal with additive noise under a situation in which the modulation scheme is not classified and a method thereof.

### DESCRIPTION OF RELATED ART

In the recent wireless communication systems, it is considered to use various modulation schemes at a transmitter depending on channel environment, e.g., weather condition, between the transmitter and a receiver. So far, a number of modulation classification methods have been considered. Among others, a Maximum Likelihood (ML) method as disclosed in Wen Wei and Jerry M. Mendel “A New Maximum-Likelihood Method for Modulation Classification,” 1995 Conference Record of the Twenty-Ninth Asilomar Conference on Signals, Systems and Computers, vol. 2, pp. 1132-1136, Oct. 30-Nov. 2, 1995 shows satisfying performance but it has too much computational complexity. From this, a qLLR (quasi Log-Likelihood Ratio) method is introduced as disclosed in C. Y. Huang and A. Polydoros “Likelihood Method for MPSK Modulation Classification,” IEEE Transactions on Communications, vol. 43, pp. 1493-1504, Feb./Mar./April 1995. Here, the qLLR method has relatively less computational complexity but it can only classify Phase Shift Keying (PSK). Therefore, there is a need for another scheme to classify Quadrature Amplitude Modulation (QAM).

In fact, in the recent communication systems, MPSK (M≧16) is not considered as a practical modulation scheme due to phase noise of hardware and poorer Bit Error Rate (BER) performance than QAM. However, the qLLR method cannot classify QAM which may be employed in the practical communication system.

Further, there is a Maximum Likelihood (ML) method that shows the best performance among other proposed blind modulation classification methods. However, this ML method still has much hardware complexity due to computation of a number of non-linear functions for test statistic. Further, since the ML method should subsequently compute for the respective samples, there are problems that numerical error would be accumulated due to limit in storing numbers with hardware and that the ML method is likely to react to frequency error or phase error sensitively.

Accordingly, there is a need for a system for reducing computational burden in classifying QAM and showing less sensitivity on the frequency error and the phase error.

### SUMMARY OF THE INVENTION

It is, therefore, an object of the present invention to provide a blind modulation classification apparatus having improved performance in non-ideal communication environment having frequency error and phase error, by reducing computational burden of test statistic and possibility of numerical error of hardware with computation of maximum likelihood for each stage independently, and a method for the same.

In accordance with an aspect of the present invention, there is provided a blind modulation classification apparatus for use in a satellite communication system, including: a plurality of likelihood computing units, each for computing a likelihood value of a received baseband signal for corresponding one of a plurality of modulation schemes; a maximum selecting and setting units for selecting the maximum among the calculated likelihood values and setting a flag corresponding to the maximum to ‘1’ and the other flags to ‘0’; a plurality of flag summing-up units for summing up the flags of the plurality of the modulation schemes; and a modulation scheme selecting unit for selecting the maximum among the summed-up values and selecting the modulation scheme corresponding to the selected value.

In accordance with another aspect of the present invention, there is provided a blind modulation classification method for use in a satellite communication system, the method comprising the steps of: computing a likelihood value of a received baseband signal for each of a plurality of modulation schemes; selecting the maximum among the calculated likelihood values and setting a flag corresponding to the maximum to ‘1’ and the other flags to ‘0’; summing up the flags of the plurality of the modulation schemes; selecting the maximum among the summed-up values; and selecting an index corresponding to the selected maximum.

Accordingly, the modulation classification block of the present invention can classify modulation scheme when a receiving side has no knowledge on the modulation scheme of a received signal and can reduce computational burden and possibility of numerical error of hardware by taking the maximum, compared to the conventional direct ML method, and has more robustness to frequency error and phase error by selecting the maximum likelihood at each stage.

### BRIEF DESCRIPTION OF THE DRAWINGS

The above and other objects and features of the present invention will become apparent from the following description of the preferred embodiments given in conjunction with the accompanying drawings, in which:

FIG. 1 illustrates one embodiment of a blind modulation classification apparatus for use in a satellite communication system in accordance with the present invention;

FIG. 2 is a flowchart for a blind modulation classification method for use in a satellite communication system in accordance with the present invention;

FIG. 3 shows graphs for modulation classification performance of a blind modulation classification apparatus in a satellite communication system under an ideal communication environment in which there is no frequency/phase error, in accordance with the present invention;

FIG. 4 shows graphs for modulation classification performance of a blind modulation classification apparatus in a satellite communication system when there is phase error, in accordance with the present invention; and

FIG. 5 shows graphs for modulation classification performance of a blind modulation classification apparatus in a satellite communication system when there is frequency error, in accordance with the present invention.

### DETAILED DESCRIPTION OF THE INVENTION

Other objects and aspects of the invention will become apparent from the following description of the embodiments with reference to the accompanying drawings, which is set forth hereinafter.

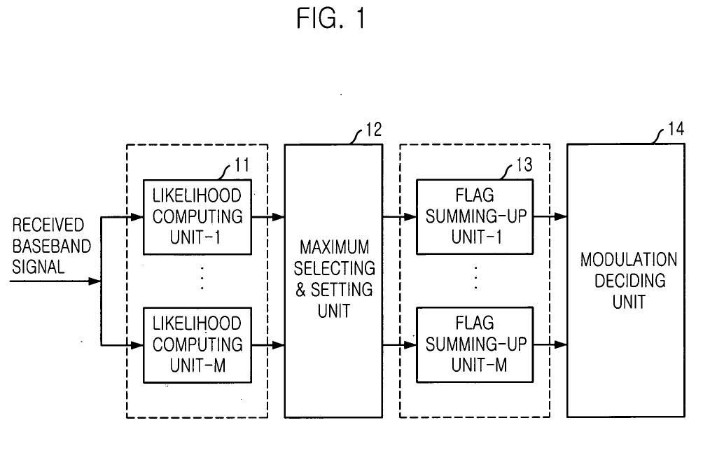

FIG. 1 illustrates one embodiment of a blind modulation classification apparatus for use in a satellite communication system in accordance with the present invention.

As shown in FIG. 1, the blind modulation classification apparatus of the present invention includes a likelihood computing unit (1-M) 11 for computing likelihood values of a received baseband signal for a number of modulation schemes, a maximum selecting and setting unit 12 for selecting the maximum among the computed likelihood values from the likelihood computing unit 11 and setting a flag corresponding to the maximum to ‘1’ and the other flags to ‘0’, a flag summing-up unit (1-M) 13 for summing up the flags of the respective modulation schemes, and a modulation scheme selecting unit 14 for selecting the maximum among the summed-up values from the flag summing-up unit 13 and selecting the modulation scheme corresponding to the selected value.

Here, the received baseband signal can be represented as following equation:
rᵢ=sᵢe^{j2πf}_{₀}^{uT}_{ₛ}^{+jθ}_{ᵢ}+nᵢ Eq. 1
where i(1≦i≦N) is symbol or sample unit time when using 1 sample per symbol, sᵢ is a modulated signal that is transmitted from a transmitter, N is the number of samples to be observed for modulation classification, nᵢ is Gaussian noise signal having power spectral density N₀/2, and f₀ and θᵢ are frequency error and phase error, respectively.

It will be described in detail for the operation of the blind modulation classification apparatus for use in a satellite communication system of the present invention in the following.

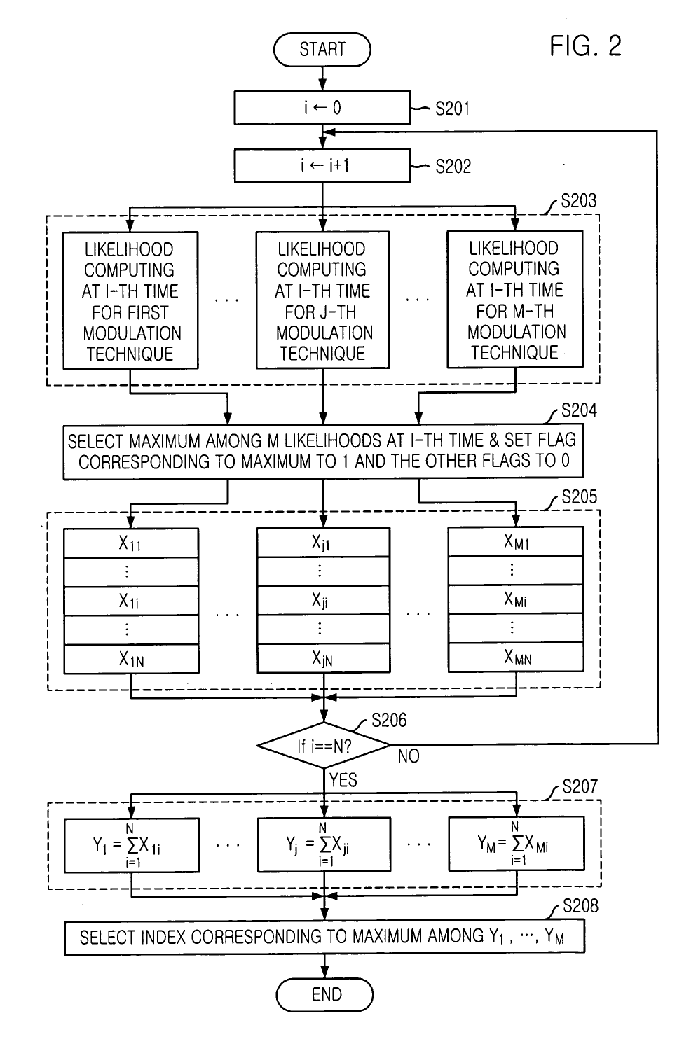

FIG. 2 is a flowchart for one embodiment of a blind modulation classification method for use in a satellite communication system in accordance with the present invention.

As shown in FIG. 2, at steps S201 to S203, the likelihood of the signal at the i-th time for the j-th modulation scheme to be classified can be computed as following equation:

$$g ( {r}_{i} \vert {M}_{j} ) = {\sum }_{k = 1}^{{M}_{j}} \frac{1}{{M}_{j}} {ⅇ}^{\frac{{\vert {r}_{i} - {x}_{kj} \vert}^{2}}{{N}_{0} / 2}} \qquad Eq . 2$$

where Mⱼ is the number of possible modulated signals of the j-th modulation scheme or the number of points in constellation of the j-th modulation scheme, and xₖⱼ is the modulated signal of the j-th modulation scheme.

In turn, based on the computed likelihoods (M likelihoods at the i-th time), the maximum is selected and a flag corresponding to the maximum is set to ‘1’ and the other flags are set to ‘0’ at step S204. It can be described following equation:
X₁ᵢ=0, . . . ,X_{Mi}=0.
If max(g(rᵢ|M₁), . . . ,g(rᵢ|M_{M}))=g(rᵢ|Mⱼ)
Xⱼᵢ=1 Eq. 3
where Xⱼᵢ is the flag of the j-th modulation at the i-th time. At step S205, the equations (2) and (3) are operated for i=1 to N, and each Xⱼᵢ is stored at a buffer.

In turn, at step S206, it is checked whether i is equal to N and, if so, the flags of the respective modulation schemes are summed up at step S207 as the following equation:

$${Y}_{j} = {\sum }_{i = 1}^{N} {X}_{ji} j = 1 , … , M \qquad Eq . 4$$

, and, if not, the steps S202 to S206 are repeated.

Then, the maximum is selected among the summed-up values Y₁, . . . , Y_{M} and an index corresponding to the selected value is selected at step S208. That is, the determined modulation scheme can be represented as the following equation:

$$K = {argmax}_{j} {Y}_{j}$$

where K is the determined modulation scheme.

To summarize, the conventional ML method takes a non-linear functional log value of each g(rᵢ|Mⱼ), which increases the amount of computations. To the contrary, the present invention makes hard-decision on g(rᵢ|Mⱼ) so that the computation burden can be reduced. Further, while the ML method is likely to accumulate numerical error for the entire j steps, the present invention completely neglects numerical error at each step so that overall numerical error could be neglected.

Furthermore, while the ML method is likely to accumulate frequency error or phase error for the respective steps that have serious effect, the present invention localizes the frequency error or phase error within each step with independent hard-decision.

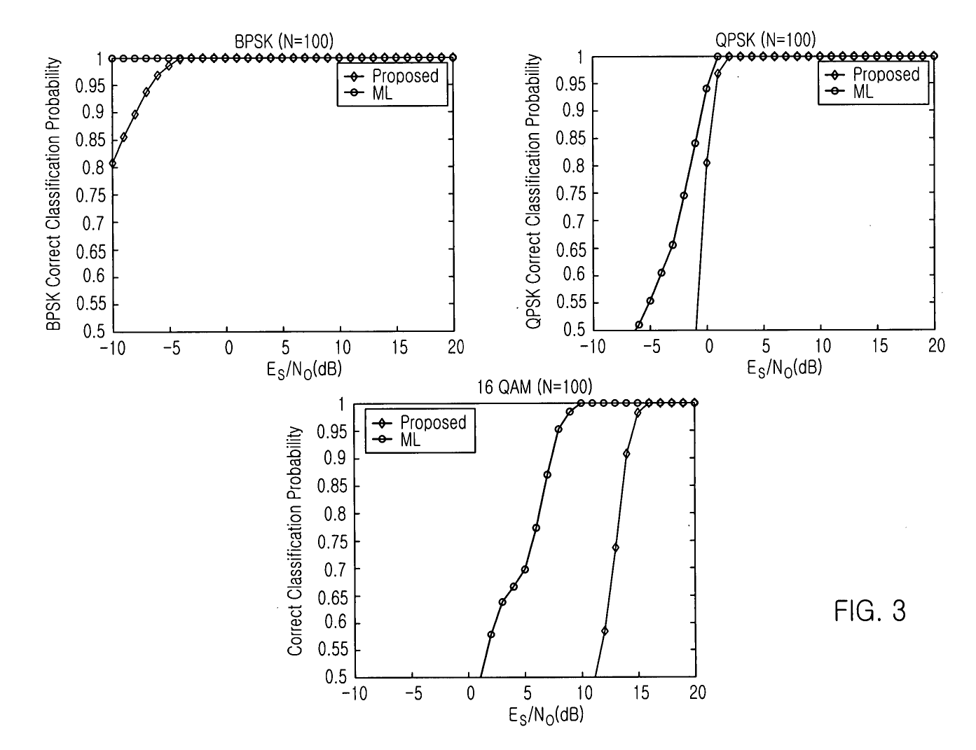

FIG. 3 shows graphs for modulation classification performance of a blind modulation classification apparatus in a satellite communication system under an ideal communication environment in which there is no frequency/phase error, in accordance with the present invention. Here, the number of samples is 100 and BPSK/QPSK/8PSK (not shown)/16QAM classification is shown.

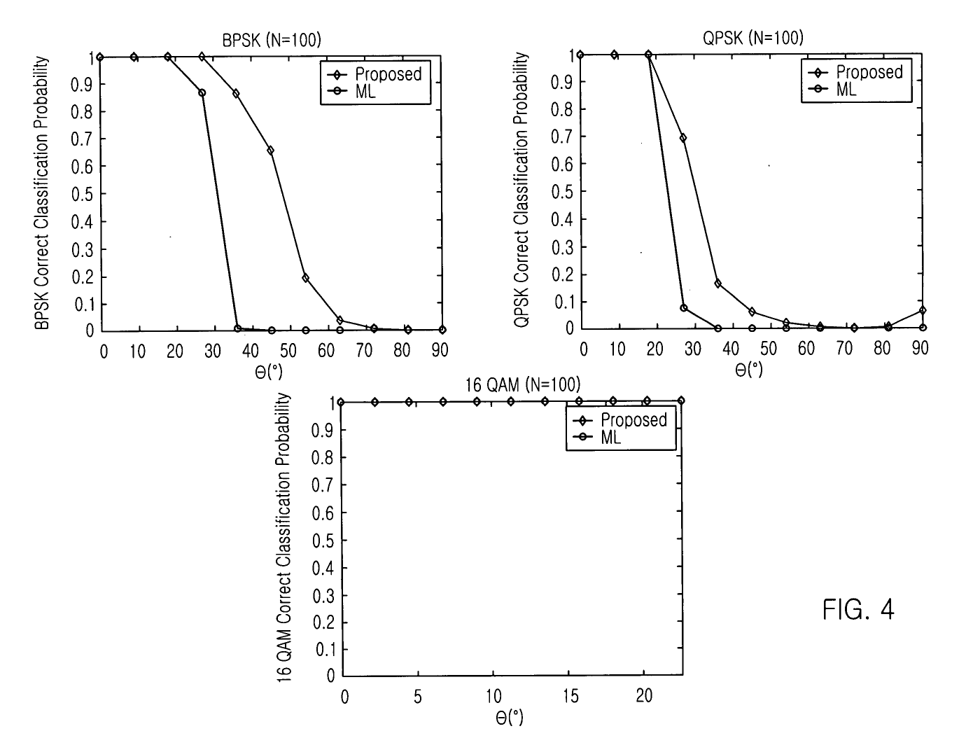

FIG. 4 shows graphs for modulation classification performance of a blind modulation classification apparatus in a satellite communication system when there is phase error, in accordance with the present invention. Here, the number of samples 100 and BPSK/QPSK: SNR=10 dB, 8PSK (not shown)/16QAM:SNR=15 dB classification is shown.

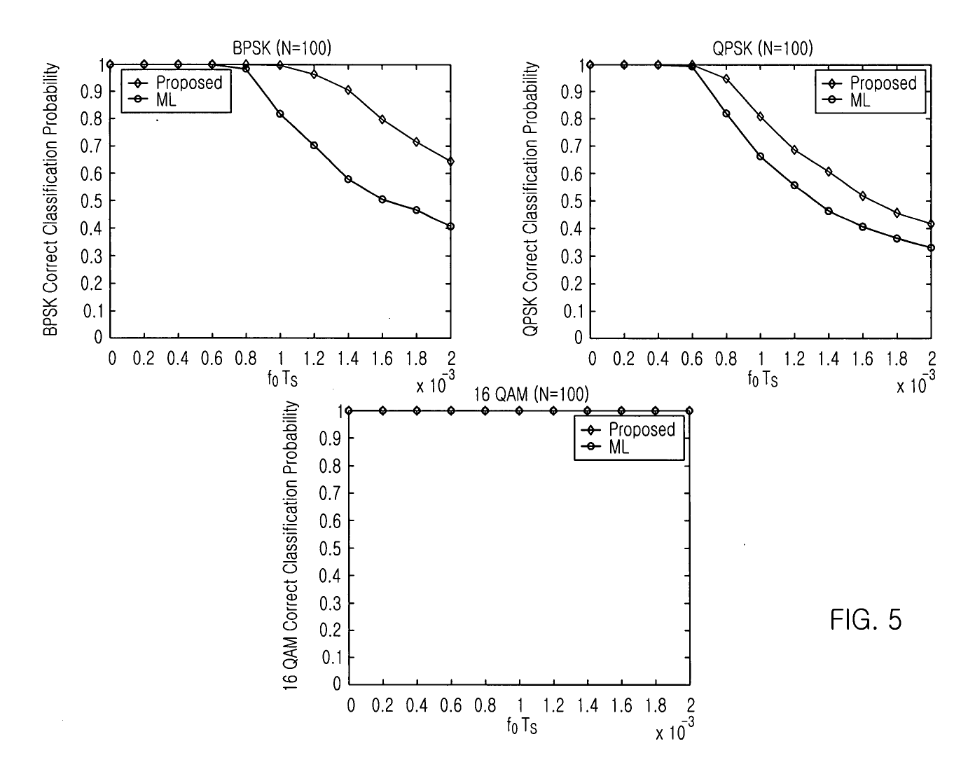

FIG. 5 shows graphs for modulation classification performance of a blind modulation classification apparatus in a satellite communication system when there is frequency error, in accordance with the present invention. Here, the number of samples 100 and BPSK/QPSK: SNR=10 dB, 8PSK (not shown)/16QAM:SNR=15 dB classification is shown.

As described above, the present invention can reduce hardware complexity in blind classification and eliminate possible numerical error due to hardware. Further, the present invention shows robust performance even under the satellite communication environment having frequency error or phase error, which can be seen in FIGS. 4 and 5. Furthermore, under the ideal environment such as an Additive White Gaussian Noise (AWGN) as shown in FIG. 3, the present invention satisfies requirement as described in “Digital Video Broadcasting (DVB); Framing structure, channel coding and modulation for Digital Satellite News Gathering (DSNG) and other contribution application by satellite,” ETSI, En 301 v.1.1, March 1999, even though the present invention is defeated by the ML method in this ideal environment.

The method of the prescribed present invention can be implemented as a program that can be stored in a computer readable recording medium, e.g., a CD-ROM, a RAM, a ROM, a floppy disc, a hard disc, a magneto optical disc and the like, which can be readily understood by the skilled in the art so as to omit detailed description of such an implementation.

As described above, the present invention can reduce computational burden for modulation classification of a received baseband signal with using the maximum among test statistics and make the modulation classification less sensitive to frequency error or phase error to have robust performance under signal variation.

Further, the present invention has robustness for numerical error accumulation due to restriction of the hardware equipments, by independently selecting the maximum among the test statistics.

The present application contains subject matter related to Korean patent application No. 2004-0098786, filed with the Korean Intellectual Property Office on Nov. 29, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A blind modulation classification apparatus for use in a satellite communication system, comprising:
a plurality of likelihood computing means, each for computing a likelihood value of a received baseband signal for corresponding one of a plurality of modulation schemes;
maximum selecting and setting means for selecting the maximum among the calculated likelihood values and setting a flag corresponding to the maximum to ‘1’ and the other flags to ‘0’;
a plurality of flag summing-up means for summing up the flags of the plurality of the modulation schemes; and
modulation scheme selecting means for selecting the maximum among the summed-up values and selecting the modulation scheme corresponding to the selected value.

2. The blind modulation classification apparatus of claim 1, wherein the likelihood is a signal at the i-th time for the j-th modulation scheme to be classified and is calculated as follows:
$$g ( {r}_{i} \vert {M}_{j} ) = {\sum }_{k = 1}^{{M}_{j}} \frac{1}{{M}_{j}} {ⅇ}^{\frac{{\vert {r}_{i} - {x}_{kj} \vert}^{2}}{{N}_{0} / 2}}$$
where Mⱼ is the number of probable modulated signals of the j-th modulation scheme or the number of points in constellation of the j-th modulation, and xₖⱼ is the modulated signal of the j-th modulation scheme.

3. A blind modulation classification method for use in a satellite communication system, comprising the steps of:
computing a likelihood value of a received baseband signal for each of a plurality of modulation schemes;
selecting the maximum among the calculated likelihood values and setting a flag corresponding to the maximum to ‘1’ and the other flags to ‘0’;
summing up the flags of the plurality of the modulation schemes;
selecting the maximum among the summed-up values; and
selecting an index corresponding to the selected maximum.

4. The blind modulation classification method of claim 3, wherein the likelihood is a signal at the i-th time for the j-th modulation scheme to be classified and is calculated as follows:
$$g ( {r}_{i} \vert {M}_{j} ) = {\sum }_{k = 1}^{{M}_{j}} \frac{1}{{M}_{j}} {ⅇ}^{\frac{{\vert {r}_{i} - {x}_{kj} \vert}^{2}}{{N}_{0} / 2}}$$
where Mⱼ is the number of probable modulated signals of the j-th modulation scheme or the number of points in constellation of the j-th modulation, and xₖⱼ is the modulated signal of the j-th modulation scheme.

5. The blind modulation classification method of claim 3, wherein the step of selecting the maximum and setting the flags includes the steps of:
computing, for i=1, . . . , N, the following equations:
$$g ( {r}_{i} \vert {M}_{j} ) = {\sum }_{k = 1}^{{M}_{j}} \frac{1}{{M}_{j}} {ⅇ}^{- \frac{{\vert {r}_{i} - {x}_{kj} \vert}^{2}}{{N}_{0} / 2}}$$
where Mⱼ is the number of probable modulated signals of the j-th modulation scheme or the number of points in constellation of the j-th modulation, and xₖⱼ is the modulated signal of the j-th modulation scheme, and
X₁ᵢ=0, . . . ,X_{Mi}=0.
If max(g(rᵢ|M₁), . . . ,g(rᵢ|M_{M}))=g(rᵢ|Mⱼ)
Xⱼᵢ=1
where Xⱼᵢ is the flag of the j-th modulation at the i-th time; and
storing each Xⱼᵢ at a buffer.

6. The blind modulation classification method of claim 5, wherein the summed-up value of the flags is calculated as following equation:
$${Y}_{j} = {\sum }_{i = 1}^{N} {X}_{ji} j = 1 , … , N$$

7. The blind modulation classification method of claim 4, wherein the step of selecting the maximum and setting the flags includes the steps of:
computing, for i=1, . . . , N, the following equations:
$$g ( {r}_{i} \vert {M}_{j} ) = {\sum }_{k = 1}^{{M}_{j}} \frac{1}{{M}_{j}} {ⅇ}^{- \frac{{\vert {r}_{i} - {x}_{kj} \vert}^{2}}{{N}_{0} / 2}}$$
where Mⱼ is the number of probable modulated signals of the j-th modulation scheme or the number of points in constellation of the j-th modulation, and xₖⱼ is the modulated signal of the j-th modulation scheme, and
X₁ᵢ=0, . . . ,X_{Mi}=0
If max(g(rᵢ|M₁), . . . ,g(rᵢ|M_{M}))=g(rᵢ|Mⱼ)
Xⱼᵢ=1
where Xⱼᵢ is the flag of the j-th modulation at the i-th time; and
storing each Xⱼᵢ at a buffer.

8. The blind modulation classification method of claim 7, wherein the summed-up value of the flags is calculated as following equation:
$${Y}_{j} = {\sum }_{i = 1}^{N} {X}_{ji} j = 1 , … , N$$
